(19) United States
(12) Patent Application Publication
(10) Pub. No.: US 2013/0187462 A1
(43) Pub. Date: Jul. 25, 2013

(54) ACTIVE LOAD MANAGEMENT SYSTEM

(71) Applicant: Briggs & Stratton Corporation, Wauwatosa, WI (US)

(72) Inventors: Sie Teong Lim, Brookfield, WI (US); Brandon M. Batzler, Hartford, WI (US); Kenny J. Stair, North Prairie, WI (US)

(73) Assignee: BRIGGS & STRATTON CORPORATION, Wauwatosa, WI (US)

(21) Appl. No.: 13/799,345

(22) Filed: Mar. 13, 2013

Related U.S. Application Data
(63) Continuation-in-part of application No. 12/792,937, filed on Jun. 3, 2010, now Pat. No. 8,415,830.

(51) Int. Cl. H02J 9/06

(52) U.S. Cl. CPC H02J 9/066
USPC 307/39

(57) ABSTRACT

A method and system for managing loads powered by a standby generator. The method includes utilizing a transfer switch control unit to selectively shed loads each associated with one of a series of priority circuits. The control unit selects the loads to shed from the generator based upon various different calculations such that the loads are shed in the least objectionable manner to the home owner. Once loads have been shed, the control unit determines whether any of the shed loads can be reconnected to the generator without exceeding the rating of the generator. The system and method allows the control units to selectively connect and disconnect priority loads to optimize the operation of the control unit to selectively shed and connect priority loads.

### CROSS-REFERENCE TO RELATED APPLICATION

The present application is a continuation-in-part application of U.S. patent application Ser. No. 12/792,937 filed Jun. 3, 2010.

### BACKGROUND

The present disclosure generally relates to a power management system. More specifically, the present disclosure relates to a power management system for managing the load applied to a standby generator.

When there is a power outage, backup power may be provided by a standby generator. In some cases, the standby generator is started automatically after detection of the power outage. A standby generator that is started automatically usually requires an automatic transfer switch to connect electrical loads to the generator rather than to the power supply. A combination of a standby generator and an automatic transfer switch is generally installed by trained personnel.

Since the power supply by the standby generator is limited by the size of the generator, the amperage rating of the generator can limit the types of and number of appliances that are connected to the standby generator during power outages. As an example, large appliances such as air conditioners, hot water heaters and on-demand appliances such as microwave ovens and toasters can draw a significant amount of power that in combination may exceed the rating limit for the standby generator.

Presently, automatic transfer switches are available that include a series of priority circuits that allow the automatic transfer switch to selectively reduce the load on the generator when the load approaches the rated limit for the generator. Typically, the priority circuits are assigned a value from 1 to a maximum number, such as 6 or 8, where the circuit assigned priority value 1 has the highest priority. When the load on the generator approaches the rating for the generator, the automatic transfer switch begins to shed load by opening switches or relays to disconnect the load connected to the lowest priority circuit. The automatic transfer switch continues to shed the loads from the lowest priority circuit to the highest priority circuit until the load reaches a preset limit to ensure that the generator can continue to provide power to the highest priority loads connected to the generator. When the load on the generator is reduced, load shedding ceases.

During initial installation of the standby generator and automatic transfer switch, installers connect dedicated loads to each of the priority circuits based upon a perceived importance of each of the loads. As an example, an air conditioner may be connected to priority circuit 1 where a less important load, such as a pool pump, may be connected to priority circuit 3. Thus, when the total load on the generator nears the rating for the generator, the pool pump connected to priority circuit 3 is shed before the air conditioner connected to priority circuit 1.

As described above, the priority circuits in currently available automatic transfer switches are hardwire connected at the time of installation. Therefore, if a user desires to change the device connected to priority circuit 1, the electrical wiring to the transfer switch must be adjusted.

### SUMMARY

The present disclosure relates to a power management system for managing the load applied to a standby generator. More specifically, the present disclosure relates to the operation of a control unit to selectively shed load from a series of priority circuits to manage the amount of load applied to the standby generator during power interruption.

The system of the present disclosure includes a transfer switch positioned between a standby generator and a main breaker panel. When power is interrupted, the transfer switch activates the generator and disconnects the supply of electricity from the utility to the main breaker panel.

After the generator begins operation, the control unit monitors the total load applied to the generator through both branch circuits and by electric loads assigned to one of a plurality of priority circuits. Each of the loads connected to the priority circuits are assigned a priority value from a lowest priority to a highest priority.

When the combined load on the generator reaches a maximum rating value for the generator, the control unit begins to selectively disconnect electric loads from a generator in a sequential order based upon the priority value assigned to each of the electric loads. The control unit continues to shed loads starting with the lowest priority load and continuing to the highest priority load until the combined load on the generator again falls below a rated value for the generator.

Once the combined load on the generator falls below the rated value, the control unit determines whether any of the previously disconnected loads having a lower priority value can be reconnected without exceeding the rated value for the generator. As an example, if a water heater connected to the second highest priority circuit is disconnected, the control unit determines whether a pool pump or similar device connected to the third highest priority circuit could be reconnected without exceeding the rated value for the generator. If the third priority circuit can be reconnected, the control unit reconnects the third priority circuit while the second priority circuit remains disconnected. The control unit continues to reconnect lower priority electric loads as long as the combined load on the generator does not exceed the rated value for the generator.

In an alternate embodiment, the control unit initially predicts the load on the generator for all of the priority loads. Based upon this predicted load on the generator for the priority loads, the control unit connects all of the priority loads possible that will keep the combined load under the generator rating. The control unit closes the contactors for the priority loads in sequential order based upon the priority value assigned to each of the electric loads. After the selected priority loads are connected to the generator, the control unit begins to monitor the actual load on the generator caused by the connected priority loads. Since one or more of the priority loads may not be active, the control unit determines whether the actual load is under the generator rating. If the actual load is below the generator rating, the control unit closes the lowest priority load that is still open. After connecting the lowest priority load, the control unit again monitors the load on the generator and if the load remains below the generator rating, priority loads are sequentially added until the actual load on the generator approaches the generator rating.

If the control unit determines that the actual load is no longer below the generator rating, the control unit calculates all possible combinations of the priority loads that can be connected to the generator while still maintaining the combined load below the rating for the generator. After all of the possible combinations have been calculated, the control unit determines the least objectionable combination and implements this combination. The least objectionable combination can be determined utilizing many different algorithms and weighting factors. As an example, the control unit may use a weighted priority calculation, an algorithm that sheds the least number of priority loads, an algorithm that sheds loads based solely on priority values, an algorithm that sheds loads based upon the time of the day, an algorithm that sheds loads based on the current season of the year or the ambient temperature, or any of the combinations above. The use of a system and method that sheds loads based upon a least objectionable solution allows the control unit to maximize the number of priority loads that can be powered by the generator without having to rely solely upon the priority values assigned by the user.

In the manner described above, the control unit optimizes the load on the generator while still maintaining the priority sequence described. During operation of the generator the control unit determines and stores the load drawn by each of the electric devices connected to the priority circuits. In this manner, the control unit can predict the additional load on the generator before each of the electric loads is reconnected out of the priority sequence order.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is an electrical system having a load management system of the present disclosure;

FIG. 2 is a schematic illustration of the priority circuits controlled by the transfer switch control board;

FIG. 3 is an illustration of the status display of the prioritized loads;

FIG. 4 is a flowchart illustrating the processing carried out by the transfer switch control board; and

FIG. 5 is a flowchart illustrating an alternate process carried out by the transfer switch control board.

### DETAILED DESCRIPTION

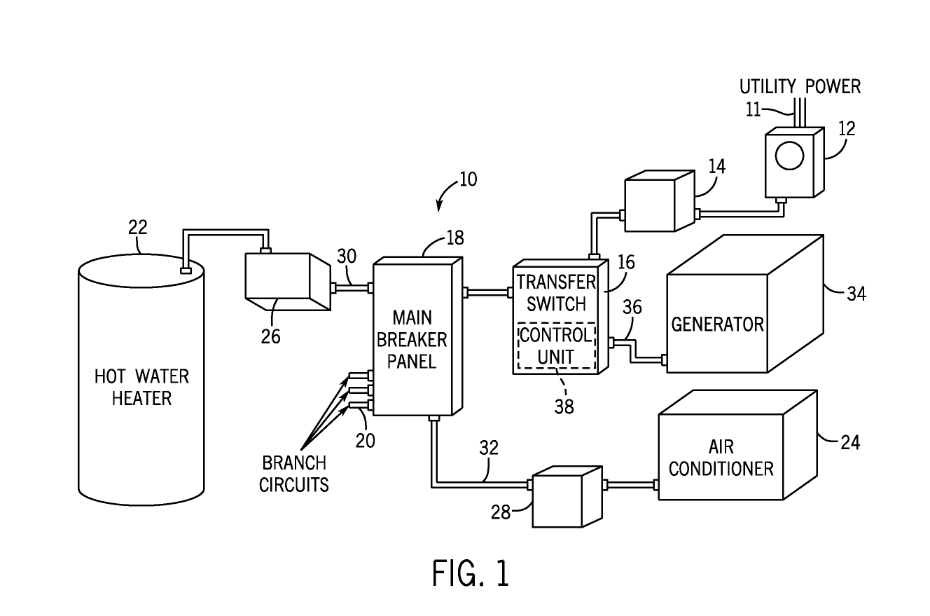

FIG. 1 depicts a load management system 10. The load management system 10 includes a connection to a main power supply 11 through a meter 12. The power supply from the meter 12 is fed through an optional service disconnect switch 14 to a transfer switch 16. The transfer switch 16 carries out a series of functions, as will be described below and can also be referred to as a load-management controller. Throughout the following disclosure, the term “transfer switch” will be utilized with the understanding that the transfer switch 16 could also be referred to as a load-management device.

The transfer switch 16 feeds electrical power to a main breaker panel 18 for the residence. The main breaker panel 18 includes a series of individual branch circuits 20 to provide electrical power to normal loads included in a residence, such as the lights, power outlets, etc.

In addition to the branch circuits 20, several high power consumption loads, such as a hot water heater 22 and air conditioner 24, are connected to the main breaker panel 18 through separate interconnect devices, such as the remote contactors 26, 28. Each of the contactors 26, 28 is shown in FIG. 1 as receiving a signal along lines 30, 32 from the transfer switch 16. The high power consumption loads can be disconnected from the power supply through the contactors 26, 28, as will be described.

Although remote contactors 26, 28 are illustrated in FIG. 1 as controlling the supply of power to each of the high power consumption loads, it is contemplated that different types of interconnect device could be utilized. As one example, instead of utilizing the remote contactors 26, 28, the transfer switch 16 could include internal relays that can be selectively opened or closed to supply power to the high power consumption loads, such as the hot water heater 22 or the air conditioner 24. Throughout the remaining portions of the disclosure, remote contactors will be shown and described. However, it should be understood that different types of interconnect devices, such as internal relays within the transfer switch 16, could be utilized while operating within the scope of the present disclosure.

The transfer switch 16 is connected to a standby generator 34 through connection 36. As is well known, when the supply of power from the utility is interrupted, a control unit within the transfer switch 16 senses the interruption of power. The transfer switch 16 sends a signal to turn on the standby generator 34 and controls switches in the transfer switch 16 to direct the supply of electricity generated by the standby generator 34 to the main breaker panel 18. When the connection is made between the generator 34 and the main breaker panel 18, the connection between the utility power supply 11 and the main breaker panel 16 is disrupted such that electricity is supplied only by the standby generator 34.

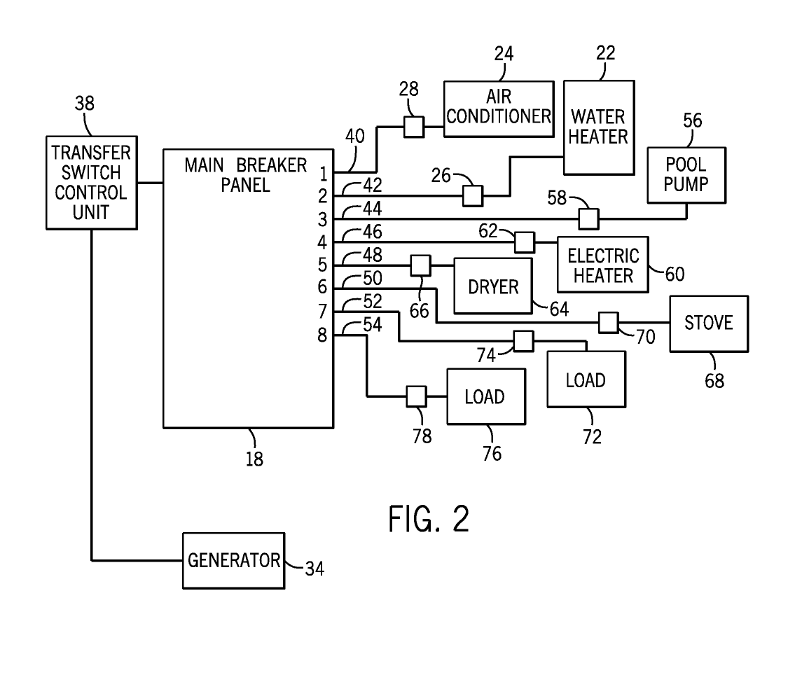

Referring now to FIG. 2, a control unit 38 of the transfer switch is shown connected to the main breaker panel 18. The control unit 38 can include any type of microcontroller that can be programmed to control the operation of various different functions of the transfer switch as is well known. In the embodiment shown in FIG. 2, only several of the connections to the main breaker panel 18 are illustrated. However, it should be understood that various other operative connections are included in the transfer switch control unit 38 and the main breaker panel 18.

The control unit 38 controls the supply of power from the standby generator to a plurality of priority circuits through a series of control outputs of the main breaker panel 18, numbered 1-8 in FIG. 2. In the embodiment shown in FIGS. 1 and 2, the control unit 38 can send separate the control outputs to the contactors 26, 28 shown in FIG. 1. The contactors 26, 28 each include a relay circuit that can be selectively opened or closed by the transfer switch control unit 38 to selectively allow power to be supplied to the hot water heater 22 or the air conditioner 24 shown in FIG. 1. As previously described, the remote contactors 26, 28 could be replaced by internal relays contained within the main breaker panel 18 and operated by the control unit 38. In addition, although the control unit 38 is shown in the transfer switch 16, the control unit 38 could alternatively be located in another location, such as in the generator or a power management module.

In the embodiment shown in FIG. 2, the air conditioner 24 is connected to the first priority output 40 through the contactor 28. Water heater 22 is connected to the second priority output 42 through the contactor 26. In the embodiment illustrated, pool pump 56 is connected to the third priority output 44 through contactor 58. An electric baseboard heater 60 is connected to the fourth priority output 46 through the contactor 62. A dryer 64 is connected to the fifth priority output 48 through contactor 66. Stove 68 is connected to the sixth priority output 50 through contactor 70. Load 72 is connected to the seventh priority output 52 through the contactor 74. Finally, load 76 is connected to the eighth priority output 54 through the contactor 78.

As illustrated in FIG. 2, the transfer switch control unit 38 controls eight priority outputs (40-54) of the main breaker panel 18 such that a total of eight individual loads can be controlled by the transfer switch control unit 38 through the priority outputs (40-54). Although eight individual priority outputs are shown in the embodiment of FIG. 2, it should be understood that the transfer switch control unit 38 could be designed having fewer or more priority outputs while operating within the scope of the present disclosure.

When electrical power is interrupted, the standby generator 34 begins to operate and supplies electric power to the transfer switch. When electric power is being supplied by the standby generator, the transfer switch control unit 38 monitors the operation of the standby generator 34 to determine the amount of power being generated by the standby generator 34 as well as the total combined load seen by the generator, which includes not only the priority circuits but also all of the loads. When the transfer switch control unit 38 detects a combined current draw from all of the loads that approaches a first percentage amount of the rated load capacity for the standby generator 34, the transfer switch control unit begins to shed loads in a manner to be described. As an example, when the load reaches approximately 85% of the rating for the standby generator 34, the transfer switch control unit 38 begins to shed loads, as will be described.

During normal operating conditions of the standby generator, when the combined load calculated by the transfer switch control unit 38 approaches the rated percentage amount for the standby generator, the transfer switch control unit initially begins to shed load by first shedding the lowest priority load 76 connected to the eighth priority output 54 through the contactor 78. Once load 76 has been shed, the transfer switch control unit again monitors for the current draw. If the current draw still exceeds the allowable threshold, the next lowest priority load 72 connected to the seventh priority output 52 is shed. This process continues until enough load is shed to bring the combined load on the generator below the rated value for the generator. As can be understood in FIG. 2, the highest priority load, which in the embodiment of FIG. 2 is air conditioner 24, is connected to the first priority output 40. The second highest priority load, namely water heater 22, is connected to the second priority output 44. Thus, when the load on the standby generator 34 exceeds the rated value, the transfer switch control unit 38 begins to sequentially shed loads from the eighth priority output 54 to the first priority output 40. Therefore, during initial installation of the contactors, the individual loads are assigned a priority number by the installer/owner.

As described above, any one of the loads can be shed by simply sending a signal from the transfer switch control unit 38 to the contactor associated with the load to cause a relay to open to interrupt power supply from the generator 34 to the individual load. Once the combined load on the generator 34 falls below the rated value, the relays contained in each of the contactors can be closed in a reverse priority order such that current from the generator is again supplied to the electric loads.

As an example, the preset maximum amount of load on the standby generator 34 is 85%, although other percentages can be used. When the total current draw drops far enough below the 85% preset maximum, additional loads can be added to the generator 34.

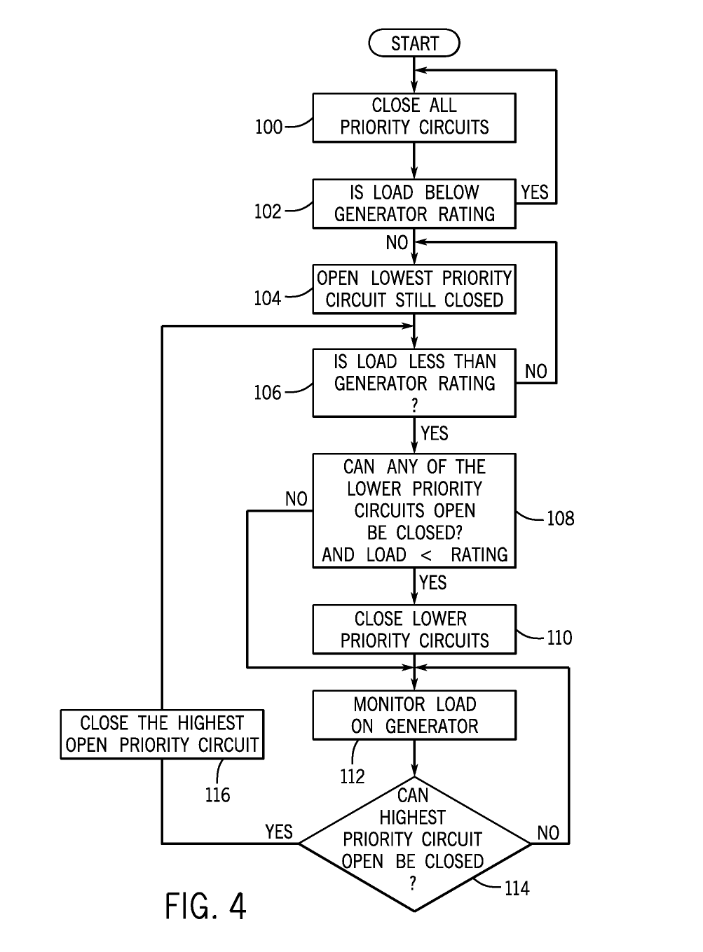

Although the priority outputs are designated in a priority sequence from the highest priority value of 1 to the lowest priority value of 8 in FIG. 2, the transfer switch control unit 38 operating in accordance with the present disclosure can modify the typical manner in which loads are shed, as will be described with reference to the flowchart of FIG. 4.

Initially, in step 100, all of the relays associated with each of the priority output lines 1-8 are closed, as indicated in step 100. The relays remain closed until the preset maximum load on the standby generator is reached.

Upon power interruption and activation of the standby generator, the control unit determines in step 102 whether the total load for a combination of all of the priority output circuits as well as the load distributed through the branch circuits 20 connected to the main breaker panel 18 in FIG. 1 is less than the generator rating. As indicated previously, the generator is typically operated at a percent of its maximum, such as 85% as described.

If the current load on the generator is less than the rating, the transfer switch control unit continues to maintain all of the priority output circuits in a closed position such that power from the generator is supplied to each of the priority loads. However, if the system determines in step 102 that the combined load is no longer below the generator rating, the system begins to shed load by initially opening the relay associated with the lowest priority circuit still closed. In the embodiment of FIG. 2, the system first opens the contactor 78 on the eighth priority output 54, as indicated by step 104 of FIG. 4. As previously indicated, the system begins shedding loads connected to the lowest priority output 54.

After the first load is shed in step 104, the system determines in step 106 whether the total load on the generator is now below the generator rating. If the total load is not below the generator rating, the system will return to step 104 and shed the next lowest priority load on the seventh priority output 52. This sequence continues until the transfer switch control unit has opened the required number of priority circuits to decrease the load on the generator below the generator rating. As an example, the transfer switch control unit may need to open the relays associated with priority outputs 5-8 to bring the total load on the generator below the generator rating.

Once enough of the load has been shed, the system determines in step 106 that the load is less than the generator rating. In prior systems, the transfer switch control unit would take no additional steps with respect to the lower priority loads and would only close the lower priority loads when the load on the generator was decreased.

However, in accordance with the present disclosure, the transfer switch control unit determines in step 108 whether any of the previously opened lower priority circuits can be opened. As an example, if the last priority circuit opened was the second priority circuit 42 connected to the water heater 22 in FIG. 2, the control unit will then determine whether the pool pump 56 connected to the third priority output 44 could be closed based on the smaller amount of power drawn by the pool pump 56 as compared to the water heater 22.

During operation, the transfer switch control unit 38 learns and stores the amount of power drawn by each of the loads shown in FIG. 2. Thus, the transfer switch control unit can predict the current load that will be drawn by the pool pump 56. If the additional load drawn by the pool pump 56 will not cause the total load to exceed the generator rating, the transfer switch control unit will close the contactor 58 and allow power to be supplied to the pool pump 56, as shown by step 110 of FIG. 4. Additionally, if the transfer switch control unit determines that any of the loads 60, 64, 68, 72 or 76 can also be connected to the generator, the control unit will close the relay associated with each individual load. As can be understood by the above description, even though electrical power is interrupted to the water heater 22 connected to the second priority output 42, the system may supply power to lower priority loads if the lower priority loads can be activated without exceeding the generator rating, as indicated by step 114.

Once the desired priority circuits are closed, the system continues to monitor the load on the generator, as shown in step 112. In step 114, the system determines whether the highest priority circuit that is open can be closed without exceeding the rating of the generator. This step ensures that the system provides power to the highest priority loads if and when the total load on the generator falls, such as when a device is turned off, such as is the case with a microwave oven. The system ensures that when the total overall load decreases, the system activates the highest priority loads first and only activates lower priority loads when the lower priority loads would not exceed the rating of the standby generator.

To continue the illustrative example described above, the system determines whether the relay to the water heater 22 connected to the second priority output can be closed to supply power to the water heater 22. In such a calculation, the load connected to the priority outputs 3-8 are eliminated from the calculation since the priority for the system is to activate the water heater 22 while shedding the load connected to the priority outputs 3-8. If the system determines in step 114 that the relay for the highest priority circuit can be closed, the system closes the relay in step 116. Once the relays have been closed, the system returns to step 106 to determine which of the relays can be closed without exceeding the rating for the generator.

In the manner described above, although various loads are connected to priority circuits based upon their importance during a load shed procedure, the transfer switch control unit is capable of activating lower priority loads if the lower priority loads will not exceed the threshold for the generator. The system continues to monitor the load on the generator and will reactivate the highest priority turned of when the highest priority turned off can be safely activated due to other reductions in energy consumption.

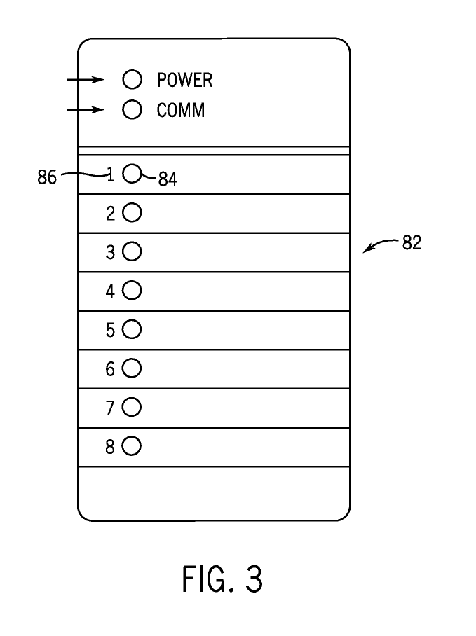

Referring to FIG. 3, the transfer switch 16 preferably includes a display 82 that has a plurality of individual indicator lights 84 positioned adjacent to a series of numeric indicators 86 representing each of the eight priority outputs. Each of the indicator lights 84 is illuminated when power is being supplied to the priority circuit associated with the indicator number 86.

In addition to the features described above, the transfer switch control unit 38 can also be configured to include memory regarding the power consumption of each individual load when the load is energized. As an example, the transfer switch control unit monitors the amount of power drawn when the air conditioner 24 is initially energized. Thus, when the air conditioner 24 is about to be energized, the transfer switch control unit 38 will shed enough load for the air conditioner to turn on without overloading the generator. After the in-rush of power consumption upon energization of the air conditioner, the power consumption of the air conditioner recedes and the transfer switch control unit 38 can again activate additional lower priority loads.

During step 108, in which the system determines whether any lower priority circuits can be closed, if the next lowest priority load will exceed the capacity of the generator, the system will proceed to the next lowest priority load to determine if this load can be turned on. Thus, as an illustrative example with respect to FIG. 12, the load applied to the third priority circuit 44 and the fourth priority circuit 46 may be turned off while the load applied to the fifth priority circuit 48 may be active. Thus, the transfer switch control unit 38 can selectively activate loads to make sure the combined load does not exceed the rating of the generator.

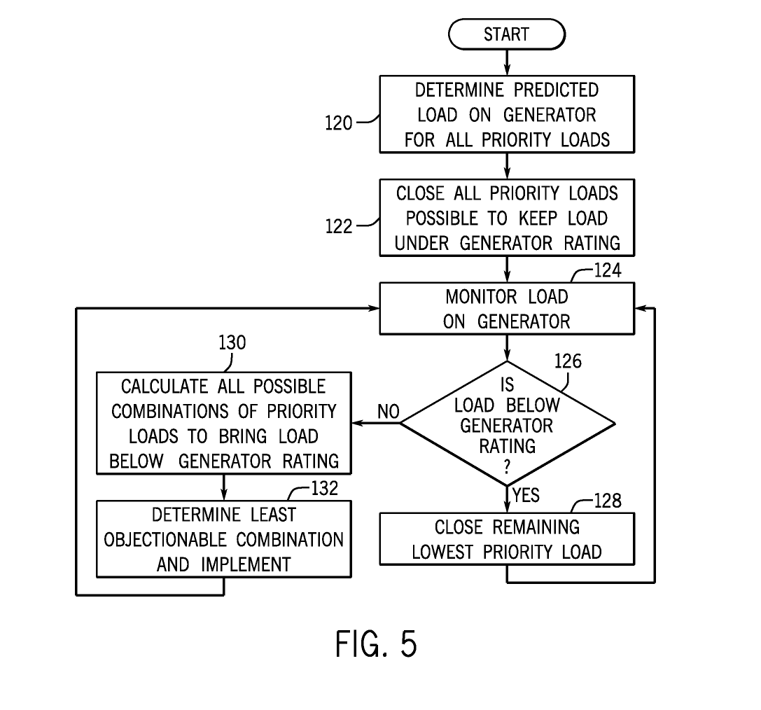

Although FIG. 4 illustrates one method of operation for the transfer switch control unit 38. FIG. 5 illustrates an alternate embodiment. As described previously, when electrical power from a utility is interrupted, the standby generator begins to operate and supplies electric power to the transfer switch. When electric power is being supplied by the standby generator, the control unit 38 monitors the operation of the standby generator 34 to determine the amount of power being, generated by the standby generator 34 as well as the total combined load seen by the generator, which includes not only the priority circuits but also all of the loads.

In the embodiment shown in FIG. 5, the control unit initially determines in step 120 the predicted load on the generator if all of the priority output circuits were connected to the generator. During operation of the system prior to transfer to electric power provided by the generator, the control unit 38 can record and store the typical power draw from each of the priority loads. As an example, the control unit monitors and stores the amount of power draw by the air conditioner 24, the water heater 22, the electric heater 60, the dryer 64 and the pool pump 56. Alternatively, the control unit could have, actual power requirement values for the priority loads pre-loaded and stored in memory, such as during the initial setup of the system. In such an embodiment, the control unit could accurately predict the load on the generator when the priority load is connected to the generator. Since each of these devices is assigned to one of the priority circuits, the control unit can determine the total power draw by a combination of the priority circuits prior to the control unit closing the remote contactors assigned to the priority loads.

After the control unit determines the predicted load for each of the priority loads in step 120, the control unit determines how many of the priority loads can be powered by the generator prior to the control unit closing the contactors for the priority loads. As an example, if the control unit determines in step 120 that the predicted load of the priority circuits 1 through 4 will allow the generator to operate below the generator rating, the system closes the contactors 28, 26, 58 and 62 through the priority output lines 40, 42, 44 and 46 in FIG. 2. The step of closing the contactors for the first four priority loads is shown in step 122 of FIG. 5.

Once the selected priority loads are connected to the generator through the transfer switch, the system proceeds to step 124 where the control unit monitors the actual load on the generator. Since the calculation made in step 120 was based upon a predicted load on the generator for the priority loads, the actual load on the generator may be different since each of the priority loads may not be operating at the time the priority loads are connected to the generator.

If the control unit determines in step 126 that the actual load on the generator is below the generator rating, the system proceeds to step 128 and connects the lowest priority load that is currently disconnected. In the embodiment described, the fifth priority load, which is the dryer 64 connected to the contactor 66, is the highest priority load that is not connected to the generator. The control unit sends a signal along the priority output line 48 to close the contactor 66 and connect the dryer 64.

After connecting the lowest priority load in step 128, the system returns to step 124 and again determines whether the monitored load on the generator is below the generator rating. The system continues this process until the actual load on the generator approaches the generator rating. As described previously, the generator is typically operated at a percent of its maximum, such as 85% of its maximum output.

The system continues to operate under this process until the system determines in step 126 that the load on the generator is no longer below the generator rating. This change in load can be caused by one of the priority loads which was previously inactive being activated. As an example, if the water heater 22, which is connected to the second priority circuit, initiates activation, the load on the generator may exceed the rated value.

In step 130, the control unit calculates all the possible combinations of the priority loads that can be connected to the generator while still maintaining the combined load below the generator rating. In the embodiment shown in FIG. 2, the system includes eight priority loads connected to the priority output lines 40-54. Since the control unit monitors the actual load on the generator for each of the priority circuits, the system determines in step 130 all the possible combinations of priority loads that can be connected based upon the actual monitored load on the generator. Since the priority loads do not all draw the same amount of power from the generator, some of the combinations will exclude the highest power consuming load, such as the air conditioner 24, while other combinations will include the highest power consuming load in combination with various combinations of the lower power consuming loads. The calculations made in step 130 are made regardless of the priority values assigned to each of the priority loads. The system simply determines in step 130 all of the possible combinations that could be connected to the generator while keeping the rating load on the generator below the generator rating.

Once all of the possible combinations are determined in step 130, the system determines in step 132 the least objectionable combination of priority circuits and the control unit then implements such a combination. The implementation of such combination will cause the contactors for the selected priority circuits to close while the contactors for the loads to be shed will be opened. As described above, prior art systems simply utilize the priority values assigned to each of the loads to determine which loads would be shed when the combined load on the generator reaches the generator rating. In the method shown in FIG. 5, the system utilizes different types of algorithms and selection criteria to determine which priority loads will be shed and which priority loads will be connected to the generator.

The determination of the least objectionable combination in step 134 can include one of multiple different algorithms for selection criteria. As a first example, the system can use a weighted priority calculation to determine which of the priority loads should be connected to the generator. The weighted priority calculation assigns a weighting value to each of the priority circuits. As an example, the first priority circuit, which is connected to the air conditioner 24, is assigned a much higher weight than the water heater connected to the second priority circuit. Likewise, the second priority circuit is assigned a higher weight than the priority circuits 3-8. The lower priority circuits, such as priority circuits 4-8, may be assigned a very similar weighting factor such that the selection of the priority circuits 4-8 will be more dependent upon the amount of power drawn by the circuit rather than the assigned priority value. In this type of configuration, the highest priority circuits are given a much higher priority and weighting value such that the higher priority circuits will be connected to the generator first. However, the lower priority circuits, which the user may not differentiate between, are selected based upon the amount of power drawn rather than the actual priority value.

In another alternate embodiment, the least objectionable combination may be determined based upon the system selecting the highest number of priority circuits that can be connected to the generator while keeping the load below the generator rating. In such an embodiment, the priority values would be secondary to the amount of power drawn by each priority circuit. As an example, if the water heater connected to the priority circuit 2 is drawing a very large amount of power, the system may shed the water heater and thus be able to connect priority circuits 1 and 3-8. In this embodiment, the system simply determines which of the priority circuits could be shed while allowing the largest number of priority circuits to remain connected to the electric generator.

In yet another alternate embodiment, the system may make a calculation in step 132 of which priority load to shed based upon the time of day. As an illustrative example, during the morning hours, the control system may determine that the electric heater 60 connected to the fourth priority circuit is a much higher priority than the pool pump 56 since the home owner desires the home to be heated in the morning hours. Thus, during the morning hours, the pool pump 56 connected to the third priority circuit is less important and can be shed. In this embodiment, the system determines which loads are more vital based upon the time of day and makes the priority load selections based upon the time of day.

In a similar manner, the control system could determine which combination is least objectionable based upon the current season of the year. Once again, the pool pump and electric heater may have different priorities to the home owner based upon the time of year. During the winter months, the electric heater may be more important to the home owner while the pool pump is less important. Thus, based upon the time of the year, the system may shift priority to the electric heater over the pool pump.

The selection of the least objectionable combination may also be based upon the ambient temperature outside of the home. In such an embodiment, if the temperature outside of the home is well above the desired temperature within the home, the system may assign a higher priority value to the air conditioner 24 connected to the first priority circuit. If the temperature outside of the home is well below the desired temperature of the home, a higher priority value may be assigned to the electric heater 60. In this manner, the system can make sure that the most desirable electric load for the user, based upon the temperature outside of the home, is selected.

Although various different priority selection solutions are described above, it should be understood that the system can use various combinations of the concepts or could utilize other, alternate solutions that have not yet been described. It is important to note that the control unit will select the least objectionable combination based upon programming and user selections such that the system can maintain the priority loads most important to the user after implementation in step 132. After implementation in step 132, the system returns to step 124 and continues to monitor the load on the generator. If the load on the generator falls below the rating, the system returns to step 128 and closes the remaining lowest priority load that is open.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method for managing a plurality of electric loads powered by a standby generator, the method comprising the steps of:
positioning an interconnect device between each of the electric loads and the generator, wherein the interconnect device is operable to selectively connect and disconnect the electric load from the generator;
assigning a priority value to each of the electric loads from a lowest priority value to a highest priority value;
providing a control unit in communication with each of the interconnect devices to control the connection of each of the electric loads to the generator;
estimating a load on the generator in the control wilt for each of the electric loads;
monitoring the combined load on the generator in the control unit;
calculating all of the possible combinations of the electric loads that will maintain the combined load on the generator below a rated value for the generator;
determining a least objectionable combination of the electric loads; and
connecting the least objectionable combination of electric loads to the generator and disconnecting the other electric loads from the generator.

2. The method of claim 1 further comprising the steps of:
determining a predicted load on the generator for each of the electric loads; and
connecting the electric loads to the generator in a sequential order of the priority values assigned to each of the electric loads from the lowest priority value to the highest priority value until the combined load reaches the rated value for the generator.

3. The method of claim 2 further comprising the step of connecting additional electric loads to the generator when the combined load on the generator is below the rated value for the generator.

4. The method of claim 3 wherein the electric loads are selectively connected based upon their priority value.

5. The method of claim 1 wherein, the least objectionable combination is determined to minimize the number of electric loads disconnected from the generator.

6. The method of claim 1 wherein the least objectionable combination is determined based upon the time of day.

7. The method of claim 1 wherein the least objectionable combination is determined based upon the current season of the year.

8. The method of claim 1 wherein, the rated value for the generator is a predetermined percentage of the maximum generator output.

9. A load management system for managing one or more electric loads powered by a standby generator, the system comprising:
a transfer switch coupled to the standby generator;
a plurality of interconnect devices each positioned between one of the loads and the generator, wherein each interconnect device is operable to selectively connect and disconnect the electric load from the generator;
a control unit in communication with each of the interconnect devices to selectively control the interconnect devices, the control unit being configured to:
estimate a load on the generator in the control unit for each of the electric loads;
monitor the combined load on the generator in the control unit;
calculate all of the possible combinations of the electric loads that will maintain the combined load on the generator below a rated value for the generator;
determine a least objectionable combination of the electric loads; and
connect the least objectionable combination of electric loads to the generator and disconnecting the other electric loads from the generator

10. The load management system of claim 9 wherein the control unit is contained within the transfer switch and the transfer switch is positioned between the generator and a main breaker panel.

11. The load management system of claim 9 wherein the rated value for the generator is a predetermined percentage of a maximum generator output.

12. The load management system of claim 9 wherein the control unit determines a predicted load on the generator for each of the electric loads and connects the electric loads to the generator in a sequential order of the priority values assigned to each of the electric loads from the lowest priority value to the highest priority value until the combined load reaches the rated value for the generator.

13. The load management system of claim 9 wherein the least objectionable combination is determined to minimize the number of electric loads disconnected from the generator.

14. The load management system of claim 9 wherein the least objectionable combination is determined based upon the time of day.

15. The load management system of claim 9 wherein the least objectionable combination is determined based upon the current season of the year.
